(19) United States
(12) Patent Application Publication
(10) Pub. No.: US 2004/0035485 A1
(43) Pub. Date: Feb. 26, 2004

(54) Method of binding polyphenylene sulfide with polyamide and products made thereof

(75) Inventors: Robert Alan Gleim, Royersford, PA (US); Changhui Zhu, Malvern, PA (US)

Correspondence Address: VOLPE AND KOENIG, P.C., UNITED PLAZA, SUITE 1600, 30 SOUTH 17TH STREET, PHILADELPHIA, PA, 19103, US

(73) Assignee: Polyflow, Inc., Oaks, PA

(21) Appl. No.: 10/427,467

(22) Filed: May 1, 2003

Related U.S. Application Data
(60) Provisional application No. 60/405,620, filed on Aug. 23, 2002.

(51) Int. Cl. F16L 9/14

(52) U.S. Cl. 138/141; 138/140; 138/137

(57) ABSTRACT

A multi-layer, composite material, and products made therefrom, having the combined properties of high strength, high chemical resistance, and low permeation to chemicals and gas. The multi-layer composite material has a barrier layer, an intermediate binding layer, and a support layer. The barrier layer is polyphenylene sulfide compounded with an ethylene/glycidyl methacrylate copolymer. The intermediate binding layer is ethylene/glycidyl methacrylate copolymer. The support layer is polyamide compounded with an ethylene/glycidyl methacrylate copolymer.

### CROSS REFERENCE TO RELATED APPLICATIONS

This is a nonprovisional application claiming priority to provisional application No. 60/405,620 filed Aug. 23, 2002, incorporated herein by reference.

### FIELD OF INVENTION

The present invention relates to a method of binding polyphenylene sulfide with polyamide to form a multi-layer composite material having the combined properties of good chemical resistance, low chemical and gas permeation, good strength, and low cost. The present invention also relates to a variety of products formed from the composite material, and in particular, reinforced pipe and tubing for use in an oil or gas well.

### BACKGROUND OF THE INVENTION

In many industrial applications, a polymeric material is needed having the combined properties of good chemical resistance, low chemical and gas permeation, good strength, and low cost. Many known polymers posses some but not all of the aforementioned properties. For example, polyphenylene sulfide is a known polymer with excellent chemical resistance and low permeation to most chemicals. However, polyphenylene sulfide is expensive. Another well-known polymer is polyamide, which has good strength and is relatively inexpensive. However, polyamide has only moderate chemical resistance and relatively high permeation to chemicals such as natural gas, oil and gasoline.

The combination of polyphenylene sulfide and polyamide would provide the aforementioned desired combination of properties. Unfortunately, there is no known method in the prior art of co-extruding, adhering or in any other way binding polyphenylene sulfide with polyamide. Therefore, it would be desirable to provide a method of binding polyphenylene sulfide and polyamide to form a composite material having a desirable combination of properties.

One industry that could benefit greatly from a polyphenylene sulfide/polyamide composite material is the petrochemical industry. As described below, a polyphenylene sulfide/polyamide composite material would be a good material for making caustic liquid handling equipment such as storage tanks, tubing and piping.

In the petrochemical industry, the transfer of oil, natural gas and other caustic fluids through the piping system of a processing plant requires special consideration of the high pressures and corrosive nature of such fluids. The poor corrosion resistance of high strength carbon steel make it unacceptable for the piping system of a chemical or petrochemical processing plant. While stainless steel provides the necessary strength and corrosion resistance for the piping system, stainless steel is very expensive. Therefore, it would be desirable to provide a polymeric tubing having an inner layer of polyphenylene sulfide for chemical resistance, and low gas and chemical permeation, and an outer layer of polyamide for improved strength and reduced cost.

Natural gas and petroleum wells usually comprise an exterior steel casing, which prevents the bore from collapsing, and an interior pipe or “production tube”, which conveys the natural gas or petroleum to the surface of the well. The production tube is suspended within the casing by a collar that connects the top of the production tube to the top of the casing. The collar positions the production tube concentrically within the casing so that an annular gap is formed between the exterior of the production tube and the interior of the casing.

Over the life-span of a well, the gradual reduction in well pressure causes a corresponding reduction in the exit velocity of the natural resource from the well through the production tube. In addition to reducing the productivity of the well, a reduction in the exit velocity below a critical value permits vaporized acids within natural gas to condense on the interior surface of the production tube.

After the exit velocity drops below an acceptable level, production from the well is boosted by inserting a reduced-diameter, co-axial velocity string within the production tube. Over the course of time, several additional reduced-diameter velocity strings may be installed until the well is tapped out.

Due to the highly-corrosive nature of oil and natural gas, and the inherently harsh subterranean conditions deep within the well, velocity strings must be made of a material having high corrosion resistance. Due to the high pressure of the fluids contained in the well, and the excessive weight of extreme lengths of the velocity string, the velocity string must also be made of a material having high strength.

It is known to make velocity strings from high-strength carbon steel, such as AISI A606 and 4130. However, high-strength carbon steel offers relatively low corrosion resistance to hydrocarbons and subterranean environments. As a result, high-strength steel velocity strings must be replaced in as little as 9-12 months from installation.

Common steel velocity strings are also very heavy and require the use of expensive special equipment during installation. For example, a high tonnage crane is often needed to lift the steel supply coil, which may weigh in excess of 20 tons. At off-shore wells, specialized barges are needed to carry to the rig the steel supply coil, as well as a the high tonnage crane.

Therefore, it would also be desirable to provide a light-weight velocity string having an inner layer of polyphenylene sulfide for chemical resistance, and low gas and chemical permeation, and an outer layer of polyamide for improved strength and reduced cost.

### SUMMARY OF THE INVENTION

The present invention relates generally to a multi-layer, co-extruded, composite material having the combined properties of high strength, high chemical resistance, low permeation to chemicals and gas, and low cost. The composite material has particular use in forming liquid containment and transfer products used in the petrochemical industry.

The multi-layer, composite material has a barrier layer, an intermediate binding layer, and a support layer. The barrier layer is made of polyphenylene sulfide compounded with an ethylene/glycidyl methacrylate copolymer. The intermediate binding layer comprises ethylene/glycidyl methacrylate copolymer. The support layer comprises polyamide compounded with an ethylene/glycidyl methacrylate copolymer.

The barrier layer preferably comprises at least about 70 percent polyphenylene sulfide. More preferably, the barrier layer comprises polyphenylene sulfide compounded with about 10 to about 30 percent of ethylene/glycidyl methacrylate copolymer.

The supporting layer preferably comprises at least about 70 percent polyamide. More preferably, the exterior supporting layer comprises polyamide compounded with about 10 to about 30 percent ethylene/glycidyl methacrylate copolymer.

The multi-layer, composite material can be used to make a wide variety of products. In one embodiment of the invention, the composite material is used to make a pipe for use in the petrochemical industry. The pipe can be made in standard sizes to cooperate with current tubing equipment, or can be customized to any other practical size.

In another embodiment, the composite material is used to make flexible tubing, which forms the inner layer of a reinforced velocity string for use in an oil or natural gas well. The velocity string comprises flexible tubing made from the composite material, a layer of reinforcement fibers surrounding the tubing, and an outer jacket surrounding the reinforcement fibers.

The reinforcement fibers of the velocity string include a first plurality of cross-braided reinforcement fibers that extend both axially and radially, and a second plurality of fibers that extend only axially. The reinforcement fibers comprise continuous filaments of high strength, weavable, braided, synthetic cordage such as aramid yarns sold under the marks Kevlar® and Twaron®.

The thickness of the individual layers of the pipe or tubing will vary depending on their overall size. The ratio of the thickness of the support layer 16 to the barrier layer 12 should preferably be greater than 1 to 1. The thickness of the binding layer 14 should be minimized, and should be less than 0.020 in., preferably about 0.002 to about 0.020 in.

### BRIEF DESCRIPTION OF THE DRAWINGS

FIG. 1 is a fragmentary, cross-sectional view of the composite material in accordance with an embodiment of the invention;

FIG. 2 is a cross-sectional view of a pipe made from the composite material shown in FIG. 1 in accordance with an embodiment of the invention;

FIG. 3 is a cross-sectional view of a velocity string having an inner flexible tube made from the composite material shown in FIG. 1 in accordance with an embodiment of the invention;

FIG. 4 is a partial cross-sectional, partial broken side elevational, partial side elevational view of the velocity string shown in FIG. 3; and,

FIG. 5 is a cross-sectional view of a velocity string in accordance with another embodiment of the invention.

### DETAILED DESCRIPTION OF PREFERRED EMBODIMENTS

Reference is made to the accompanying drawings wherein like reference numerals are used throughout to designate like elements. As used herein, the term “percent” shall means percent by weight.

A multi-layer, composite material in accordance with an embodiment of the invention is shown in FIG. 1, and is designated generally by reference numeral 10. The material 10 has a barrier layer 12, an intermediate binding layer 14, and a support layer 16. The relative thicknesses of the individual layers shown in FIG. 1 is merely for illustrative purposes and is not representative of the actual thickness ratios of the material in accordance with the preferred embodiments.

The barrier layer 12 is formed from a material that is resistant to corrosion by chemicals and hydrocarbons such as natural gas and petroleum. In a preferred embodiment, the barrier layer is formed from polyphenylene sulfide compounded with ethylene/glycidyl methacrylate copolymer. Polyphenylene sulfide is used because it has good chemical corrosion resistance, and has a very low permeation to most chemicals including hydrocarbons. Preferably, the polyphenylene sulfide is compounded with about 10 to about 30 percent ethylene/glycidyl methacrylate copolymer. Both polyphenylene sulfide and ethylene/glycidyl methacrylate copolymer are commercially available polymer resins.

The support layer 16 is formed from a material that has improved strength and a lower cost than polyphenylene sulfide. In a preferred embodiment, the exterior layer comprises polyamide compounded with ethylene/glycidyl methacrylate copolymer. Polyamide is used because it is a low cost engineering polymer with balanced mechanical properties. Preferably, polyamide is compounded with about 10 to about 30 percent ethylene/glycidyl methacrylate copolymer. Polyamide is also a commercially available polymer resin.

The intermediate layer 14 comprises ethylene/glycidyl methacrylate copolymer. Normally, polyphenylene sulfide and polyamide can not be bound or even adhered to one another. The use of ethylene/glycidyl methacrylate as an intermediate binding layer 14, and as a compounding element of the polyphenylene sulfide layer 12 and polyamide layer 16, allows the layers 12,16 to be bound to one another.

In a preferred embodiment of the invention, polyphenylene sulfide and ethylene/glycidyl methacrylate copolymer are compounded using a single screw or twin-screw compounding line which includes a compounding extruder and a pelletizer. Polyphenylene sulfide and ethylene/glycidyl methacrylate copolymer can be pre-mixed or meter fed into the extruder in the ratios described above. Preferably, the temperature of the extruder and die is about 450 to about 600° F. After extrusion, the compound is pelletized for use in a subsequent extruding process that forms the multi-layer, composite material into various product shapes.

In a preferred embodiment of the invention, polyamide and ethylene/glycidyl methacrylate copolymer are compounded using a twin-screw compounding line that includes a compounding extruder and a pelletizer. Polyamide and ethylene/glycidyl methacrylate copolymer can be pre-mixed or meter fed into the extruder in the ratios described above. Color pigment or a nylon base color concentrate can be introduced if desired. Preferably, the temperature of the extruder and die is about 400 to about 600° F. After extrusion, the compound is pelletized and dried for use in a subsequent extrusion process that forms the multilayer, composite material into various product shapes.

As described above, the multi-layer, composite material 10 can be used to make a wide variety of products. The composite material has particular use in products that contain or convey corrosive materials. For example, as described below, the composite material 10 can be used to make piping, tubing and storage tanks for use in the petrochemical industry. The composite material 10 can also be extruded in thin films and used as a barrier material to corrosive environmental conditions. However, those of ordinary skill in the art will appreciate that use of the composite material 10 is clearly not limited to the products described below.

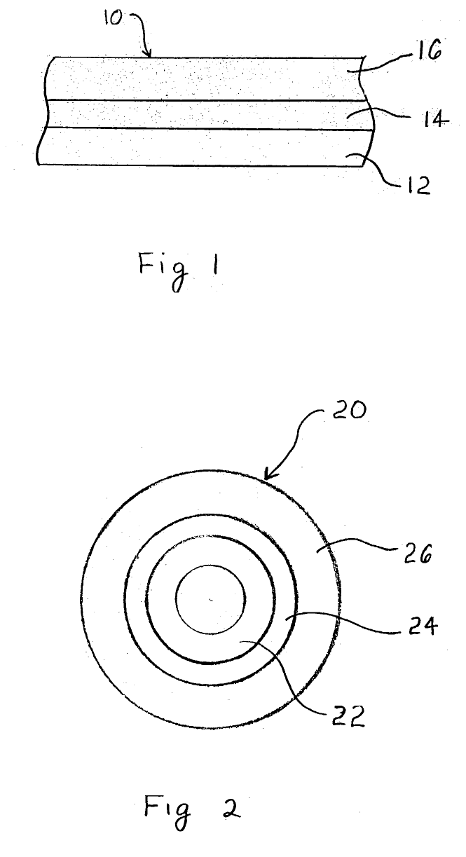

In another embodiment of the invention, the composite material 10 is used to make an extruded pipe 20 for use in conveying corrosive fluids. Referring to FIG. 2, the pipe 20 has an interior barrier layer 22, an intermediate binding layer 24, and a support layer 26. The ratio of thicknesses of the individual layers shown in FIG. 2 is merely for illustrative purposes and is not representative of the actual thickness ratios of the material in accordance with the preferred embodiments. The pipe 20 is formed using the co-extrusion process described below. The material 10 is extruded so that the polyphenylene sulfide forms the interior barrier layer 22 and the polyamide forms the exterior support layer 26 of the pipe 20.

The pipe 20 of the present invention can be made in standard sizes or can be customized to any other practical size. The thickness of the individual layers will vary depending on the overall size of the pipe 20. However, the thickness of the individual layers will vary depending on the overall size of the tubing 30. For the best balanced properties of high chemical resistance, low chemical and gas permeation to hydrocarbons, high axial and radial strength, and low cost, the thickness ratio of the exterior support layer 36 to the interior barrier layer 32 should preferably be greater than 1 to 1. The thickness of the binding layer 34 should be minimized, and should be less than 0.020 in., preferably about 0.002 to about 0.020 in. For practical applications, the support layer should be at least about 0.030 in. thick and the barrier layer should be at least about 0.001 in. thick.

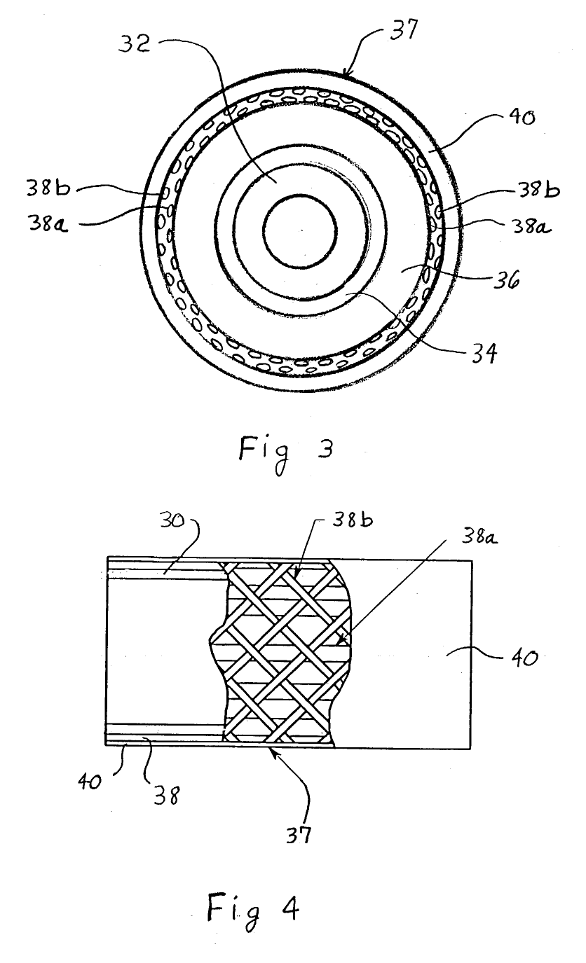

In another embodiment of the invention, the composite material 10 is used to make flexible tubing 30 which forms the inner layer of a velocity string used in an oil or natural gas well. Referring to FIGS. 3 and 4, the velocity string, designated generally be reference numeral 37, comprises the multi-layer tubing 30, a plurality of reinforcement fibers 38 surrounding the tubing 30, and an outer jacket 40 surrounding the reinforcement fibers.

The tubing 30 has an interior barrier layer 32, an intermediate binding layer 34, and a support layer 36. The ratio of thicknesses of the individual layers shown in FIG. 2 is merely for illustrative purposes and is not representative of the actual thickness ratios of the material in accordance with the preferred embodiments.

The tubing 30 is formed using the co-extrusion process described below. The material is extruded so that the polyphenylene sulfide forms the interior barrier layer 32 and the polyamide forms the exterior support layer 36 of the tubing.

The tubing 30 of the present invention can be made in standard sizes to cooperate with current tubing equipment, or can be customized to any other practical size. The thickness of the individual layers will vary depending on the overall size of the tubing 30. For the best balanced properties of high chemical resistance, low chemical and gas permeation to hydrocarbons, high axial and radial strength, and low cost, the thickness ratio of the exterior support layer 36 to the interior barrier layer 32 should preferably be greater than 1 to 1. The thickness of the binding layer 34 should be minimized, and should be less than 0.020 in., preferably about 0.002 to about 0.020 in. For practical applications, the support layer 36 should be at least about 0.030 in. thick and the barrier layer should be at least about 0.001 in. thick. For example, for tubing having a 1 in. outer diameter and a 0.07 in. wall thickness, the barrier layer 32 is about 0.002 to 0.020 in. thick and the supporting layer is about 0.030 to about 0.060 in. thick.

The velocity string 37 has both axially-extending fibers 38a and cross-braided fibers 38b. The reinforcement fibers 38 provide increased tensile and radial strength. The layer of reinforcement fibers 38 is preferably formed in a continuous co-extrusion process, with the axial and cross-braided fibers being introduced into the extruding process so that they are captured and held in position between the tubing 30 and the jacket 40.

In the embodiment shown in FIGS. 3 and 4, the axially-extending fibers 38a comprise continuous filaments of a high-strength, braided, synthetic cordage such as the aramid yarns sold under the marks Kevlar® or Twaron®. However, those skilled in the art will appreciate that other fibers can be used in combination with or as a replacement for the aramid yarns. The fibers should be loosely packet to allow some slippage, which allows the string 37 to bend without kinking.

Referring to FIG. 4, the axially-extending fibers 38a extend along the length of the velocity string 37. The axially-extending fibers 38a increase the axial tensile strength of the velocity string 37, and prevent necking when extremely long lengths, e.g., 5000 feet or more, of string 37 are suspended in the well. In the embodiment shown in FIG. 3, the fibers 38a are applied over the exterior support layer 32 of the tubing 30 during extrusion.

The cross-braided fibers 38b extend around the periphery of the tubing and are applied over the axially-extending fibers 38a. The cross-braided fibers 38b increase the radial tensile or hoop strength of the tubing 30 to resist outward pressure from the fluid contained within the tubing 30. In the embodiment shown in FIGS. 3 and 4, the cross-braided fibers also comprise continuous filaments of a high-strength, braided, synthetic cordage such as the aramid yarns sold under the marks Kevlar® or Twaron®. The cross-braided fibers 38b are preferably applied over the axially-extending fibers 38a during extrusion.

The outer jacket 40 is formed from a material that has improved strength and a lower cost than polyphenylene sulfide, and can withstand long term exposure to underground conditions. Selection of the jacket material is also based on the chemical resistance needed for the particular well. In a preferred embodiment, the jacket comprises a high strength polymeric material such as polyamide, such as the material sold under the mark Nylon®, or may be material having good corrosion resistance such as the polyphenylene sulfide material sold under the mark Fortron®, or may be a blend of such materials. For “sweet” wells containing relatively low amounts of corrosive impurities, the preferred material is Nylon®. For “sour” wells containing deleterious amounts of corrosive impurities, the preferred jacket material is Fortron®.

The outer jacket 40 is preferably at least 0.030 in. thick to prevent damage to the reinforcement fibers 18 during installation. In general, the outer jacket 40 may be thicker than 0.030 in. to provide a smooth exterior surface, which enhances installation into the well. The outer jacket 40 is preferably applied over the reinforcement fibers 38 during extrusion.

It is preferred that the weave density of the reinforcement fibers 38 be sufficient to prevent bonding between the outer jacket 40 and the exterior of the tubing 30, except for weak mechanical contacts at the interstitial gaps in the fabric pattern. If significant bonding between the jacket 40 and the tubing 30 occurs, the reinforcement fibers 38 will be prevented from shifting when the pipe is bent, thereby causing the pipe to kink rather than bend.

The outer diameter of the velocity string preferably ranges from about 1.0 to about 2.375 in. The thickness of each layer varies based on the diameter of the pipe tubing 30. The diameter of the tubing 30 is selected so that the string 37 may be coiled and handled easily without kinking.

The pipe 20 and the tubing 30 are both preferably made using a coextrusion process. The process preferably utilizes three extruders, which can be single screw extruders and/or twin screw extruders.

The first extruder melts and extrudes the compound of polyphenylene sulfide and ethylene/glycidyl methacrylate copolymer to form the barrier layer. Preferably, the first extruder operates at about 450 to about 600° F. and at about 2,000 to about 7,000 p.s.i.

The second extruder melts and extrudes the compound of polyamide and ethylene/glycidyl methacrylate copolymer to form the supporting layer. Preferably, the second extruder operates at about 400 to about 600° F. and at about 1,000 to about 7,000 p.s.i.

The third extruder melts and extrudes ethylene/glycidyl methacrylate copolymer to form the intermediate binding layer. Preferably, the third extruder operates at about 350 to about 570° F., and at about 500 to about 3,000 p.s.i. On all three extruders, the temperature range of the die is about 450 to about 650° F.

While the extrusion process is described with reference to formation of a pipe and tubing, it should be appreciated by those skilled in the art that the multi-layer composite material can be formed into other shapes or products by replacing the pipe-forming die with, for example, a sheet extrusion die, a film extrusion die, or a profile extrusion die.

While the pipe 20 and tubing 30 have been described above with particular application to hydrocarbon transport, those skilled in the art will appreciate that the pipe 20 and tubing 30 may be used to transport a variety of pressurized corrosive fluids. However, it is recommended that the composite material not be used to make products that will experience environmental conditions in excess of about 250° F. Above about 250° F., the bond between the barrier layer and support layer begins to weaken.

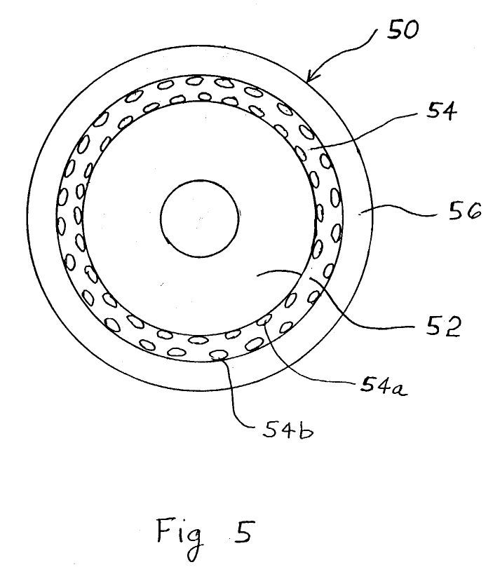

A velocity string in accordance with another embodiment of the invention is shown in FIG. 5. The velocity string 50 comprises a continuous tube of polymeric material 52, a layer of reinforcement fibers 54 surrounding the tube, and an outer jacket 56 surrounding the reinforcement fibers 54. The velocity string 50 illustrated in FIG. 5 is similar to the velocity string 37 shown in FIGS. 3 and 4, except the inner tube 52 of the velocity string shown in FIG. 5 comprises a single-layer extrusion and not a multi-layer extrusion as shown in FIGS. 3 and 4. The inner tube 52 may be formed from a thermoplastic material having good corrosion resistance, such as polyphenylene sulfide sold under the mark Fortron®, for use in corrosive environments. Alternatively, the inner tube 52 may be formed from a less expensive material having higher strength but lower corrosion resistance than polyphenylene sulfide, such as polyamide sold under the mark Nylon®, for use in non-corrosive environments. The inner tube 52 is preferably extruded as a continuous tube having sufficient flexibility so that it can be wound onto a commercial tubing reel. Preferably, the inner tube is about 0.050 to about 0.250 in. thick.

The outer jacket 56 is similar to the outer jacket 40 described above. Preferable, the outer jacket 56 is at least about 0.030 in thick to prevent damage to the reinforcement fibers 54 during installation.

The reinforcement fibers 54 are similar to the reinforcement fibers 38 described above. The reinforcement fibers 54 include a plurality of axially-extending fibers 54a and a plurality of cross-braided fibers 54b.

The velocity string 50 is preferably co-extruded in the same manner as disclosed above, except the inner tube 52 is extruded as a single layer. Because the continuous tube 52 of the velocity string 50 does not include the binding layer 34, use of the velocity string 50 in accordance with this embodiment of the invention is not limited to environmental temperatures less than about 250° F. Therefore, the velocity string 50 has particular use in deep wells where the temperature exceeds 250° F. inside the well.

The present invention is not limited to the specific embodiments described above. Further modifications and extensions of the present invention may be developed and all such modifications are deemed to be encompassed within the spirit and scope of the present invention.

What is claimed is:

1. A multi-layer, composite material, comprising:
a) a barrier layer comprising polyphenylene sulfide;
b) a support layer comprising polyamide; and,
c) an intermediate layer binding said barrier layer and support layer to one another.

2. The composite material recited in claim 1, wherein said barrier layer comprises polyphenylene sulfide compounded with an ethylene/glycidyl methacrylate copolymer; said intermediate binding layer comprises ethylene/glycidyl methacrylate copolymer; and, said support layer comprises polyamide compounded with an ethylene/glycidyl methacrylate copolymer.

3. The composite material recited in claim 1, wherein said barrier layer comprises at least about 70 percent polyphenylene sulfide.

4. The composite material recited in claim 2, wherein said barrier layer comprises polyphenylene sulfide compounded with about 10 to about 30 percent ethylene/glycidyl methacrylate copolymer.

5. The composite material recited in claim 1, wherein said supporting layer comprises at least about 70 percent polyamide.

6. The composite material recited in claim 2, wherein said supporting layer comprises polyamide compounded with about 10 to about 30 percent ethylene/glycidyl methacrylate copolymer.

7. A method of binding polyphenylene sulfide to polyamide, comprising the steps of:
a) compounding polyphenylene sulfide with ethylene/glycidyl methacrylate copolymer to form a polyphenylene sulfide compound;
b) compounding polyamide with ethylene/glycidyl methacrylate copolymer to form a polyamide compound;
c) co-extruding a first layer of said polyphenylene sulfide compound, a second layer of said polyamide compound, and an intermediate layer of ethylene/glycidyl copolymer in between said first and second layers.

8. The method recited in claim 7, wherein the polyphenylene sulfide compound comprises at least about 70 percent of polyphenylene sulfide.

9. The method recited in claim 7, wherein the polyphenylene sulfide compound comprises about 10 to about 30 percent ethylene/glycidyl methacrylate copolymer.

10. The method recited in claim 7, wherein the polyamide compound comprises about 70 percent polyamide.

11. The method recited in claim 7, wherein the polyamide compound comprises about 10 to about 30 percent ethylene/glycidyl methacrylate copolymer.

12. A multi-layer, extruded, composite pipe, comprising:
a) an interior barrier layer comprising polyphenylene sulfide;
b) an exterior support layer comprising polyamide; and,
c) an intermediate layer binding said interior layer and exterior layer to one another.

13. The pipe recited in claim 12, wherein said interior barrier layer comprises polyphenylene sulfide compounded with an ethylene/glycidyl methacrylate copolymer; said intermediate binding layer comprises ethylene/glycidyl methacrylate copolymer; and, said exterior support layer comprises polyamide compounded with an ethylene/glycidyl methacrylate copolymer.

14. The pipe recited in claim 12, wherein said barrier layer comprises at least about 70 percent polyphenylene sulfide.

15. The pipe recited in claim 13, wherein said barrier layer comprises polyphenylene sulfide compounded with about 10 to about 30 percent ethylene/glycidyl methacrylate copolymer.

16. The pipe recited in claim 12, wherein said exterior supporting layer comprises at least about 70 percent polyamide.

17. The pipe recited in claim 13, wherein said exterior supporting layer comprises polyamide compounded with about 10 to about 30 percent ethylene/glycidyl methacrylate copolymer.

18. The pipe recited in claim 12, wherein said pipe is co-extruded.

19. The pipe recited in claim 12, wherein the ratio of the thickness of the supporting layer to the barrier layer is greater than 1 to 1.

20. The pipe recited in claim 12, wherein the thickness of the binding layer is less than about 0.020 in.

21. The pipe recited in claim 20, wherein the thickness of the binding layer is about 0.001 in. to about 0.020 in.

22. The pipe recited in claim 12, wherein the thickness of the barrier layer is about 0.002 in. to about 0.040 in.

23. The pipe recited in claim 12, wherein the thickness of the supporting layer is at least about 0.030 in.

24. A velocity string for use in a hydrocarbon well, comprising:
a) a multi-layer, extruded, composite tube, including:
i) an interior barrier layer comprising polyphenylene sulfide;
ii) an exterior support layer comprising polyamide; and,
iii) an intermediate layer binding said interior layer and exterior layer to one another;
b) a layer of reinforcement fibers surrounding said tube; and,
c) an outer jacket surrounding said reinforcement fibers.

25. The velocity string recited in claim 24, wherein said interior barrier layer comprises polyphenylene sulfide compounded with an ethylene/glycidyl methacrylate copolymer; said intermediate binding layer comprises ethylene/glycidyl methacrylate copolymer; and, said exterior support layer comprises polyamide compounded with an ethylene/glycidyl methacrylate copolymer.

26. The velocity string recited in claim 24, wherein said barrier layer comprises at least about 70 percent polyphenylene sulfide.

27. The velocity string recited in claim 25, wherein said barrier layer comprises polyphenylene sulfide compounded with about 10 to about 30 percent ethylene/glycidyl methacrylate copolymer.

28. The velocity string recited in claim 24, wherein said exterior supporting layer comprises at least about 70 percent polyamide.

29. The velocity string recited in claim 25, wherein said exterior supporting layer comprises polyamide compounded with about 10 to about 30 percent ethylene/glycidyl methacrylate copolymer.

30. The velocity string recited in claim 24, wherein said tube is coextruded.

31. The velocity string recited in claim 24, wherein the ratio of the thickness of the supporting layer to the barrier layer is greater than 1 to 1.

32. The velocity string recited in claim 24, wherein the thickness of the binding layer is less than about 0.020 in.

33. The velocity string recited in claim 32, wherein the thickness of the binding layer is about 0.002 in. to about 0.020 in.

34. The velocity string recited in claim 24, wherein the thickness of the barrier layer is about 0.002 in. to about 0.040 in.

35. The velocity string recited in claim 24, wherein the thickness of the supporting layer is about 0.030 in. to about 0.060 in.

36. The velocity string recited in claim 24, wherein said reinforcement fibers include a first plurality of reinforcement fibers that extend both axially and radially, and a second plurality of the fibers that extend only axially.

37. The velocity string recited in claim 36, wherein said first plurality of fibers are cross-braided.

38. A velocity string for use in a hydrocarbon well, comprising:
a) a continuous extruded, polymeric tube; and,
b) a layer of reinforcement fibers surrounding said tube including a first plurality of reinforcement fibers that extend both axially and radially, and a second plurality of the fibers that extend only axially.

39. The velocity string recited in claim 38, including an outer jacket surrounding said reinforcement fibers.

40. The velocity string recited in claim 38, wherein said polymeric tube is formed from a thermoplastic material.

41. The velocity string recited in claim 38, wherein said jacket is formed from a thermoplastic material.

42. The velocity string recited in claim 40, wherein said material is selected from the group consisting of the polyamide material sold under the mark Nylon® and the polyphenylene sulfide material sold under the mark Fortron®.

43. The velocity string recited in claim 41, wherein said material is selected from the group consisting of the polyamide material sold under the mark Nylon® and polyphenylene sulfide material sold under the mark Fortron®.

44. The velocity string recited in claim 39, wherein said velocity string is co-extruded.

45. The velocity string recited in claim 38, wherein said first plurality of fibers are cross-braided.
